(19) United States
(12) Patent Application Publication
(10) Pub. No.: US 2024/0391379 A1
(43) Pub. Date: Nov. 28, 2024

(54) SYSTEMS AND METHODS FOR VIRTUAL CONNECTION-BASED BRAKE LIGHT CONTROL

(71) Applicant: Toyota Motor Engineering & Manufacturing North America, Inc., Plano, TX (US)

(72) Inventor: Lisa Maitre, Milford, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/322,901

(22) Filed: May 24, 2023

(51) Int. Cl. B60Q 1/44; B60Q 1/50

(52) U.S. Cl. CPC B60Q 1/44; B60Q 1/508; B60Q 2400/20

(57) ABSTRACT

System, methods, and other embodiments described herein relate to illuminating a brake light of a following vehicle based on information obtained during a virtual connection mode. In one embodiment, a system includes a processor and a memory storing machine-readable instructions that, when executed by the processor, cause the processor to, when a lead vehicle and a following vehicle are in a virtual connection mode, 1) prevent a brake light of the following vehicle from illuminating based on a default brake light signal and 2) illuminate the brake light of the following vehicle based on information obtained during the virtual connection mode.

### TECHNICAL FIELD

The subject matter described herein relates, in general, to controlling vehicle brake lights and, more particularly, to controlling vehicle brake lights based on information obtained while the vehicle is in a virtual connection mode.

### BACKGROUND

In a hitched configuration, a trailer or another wheeled object is physically coupled to a motorized vehicle such that the motorized vehicle pulls the trailer or other wheeled object along and behind the motorized vehicle. Two vehicles may be joined in a virtual connection configuration, such as a hitchless/virtual towing configuration or a platooning configuration. In a hitchless/virtual towing configuration, a lead vehicle is manually or autonomously controlled, while a following vehicle is at least partially controlled by the lead vehicle. The following vehicle trails the lead vehicle as if physically coupled to the lead vehicle. Platooning is another configuration in which multiple vehicles maneuver in a coordinated fashion. A vehicle at the front of the platoon controls the speed and/or maneuvers of the other vehicles.

### SUMMARY

In one embodiment, example systems and methods relate to a manner of improving virtual connection recognition by illuminating a brake light of a virtually-connected following vehicle based on information obtained during the virtual connection rather than a default brake light signal.

In one embodiment, a brake light control system includes one or more processors and a memory communicably coupled to the one or more processors. The memory stores a control module including instructions that when executed by the one or more processors cause the one or more processors to, when a lead vehicle and a following vehicle are in a virtual connection mode, 1) prevent a brake light of the following vehicle from illuminating based on a default brake light signal and 2) illuminate the brake light of the following vehicle based on information obtained during the virtual connection mode.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a brake light control system that illuminates a brake light based on information obtained during the virtual connection mode.

FIG. 3 illustrates one example of controlling the brake light of the following vehicle based on information obtained during the virtual connection mode.

FIG. 4 illustrates one embodiment of a method for controlling the brake light of the following vehicle based on information obtained during the virtual connection mode.

### DETAILED DESCRIPTION

Systems, methods, and other embodiments associated with improving the execution of virtual vehicle connections by filtering, or masking, default brake light signals in favor of a brake light signal that is based on information associated with a virtual connection of vehicles. In a virtual connection configuration, which may include a hitchless towing, a virtual towing, or a platooning configuration, a lead vehicle is manually or autonomously controlled, while a following vehicle is at least partially controlled by the lead vehicle. In any of these configurations, the following vehicle may follow the lead vehicle by a predetermined distance. To precisely maintain this distance between the vehicles, the following vehicle may frequently apply brake pressure, sometimes in short bursts. This frequent braking results in a flickering of the brake lights of the following vehicle. The flickering of the brake lights may confuse other road users, such as motorists and pedestrians. In general, confusion leads to an increased incidence of unsafe conditions.

To address any incident that may arise, or have a higher likelihood of arising, due to the confusion potentially exhibited by other individuals, the present invention disclosure form describes a system that masks the frequent braking by the following vehicle to reduce the flickering of the following vehicle brake lights. As such, confusion resulting from brake light flickering is avoided, and this trigger to a potentially unsafe environment is avoided.

In one example, the system activates the brake lights of the following vehicle in a particular pattern that indicates that the following vehicle is virtually connected/hitched to the lead vehicle. For example, the system may control the brake lights of the following vehicle to flash at a specific frequency (e.g., a frequency similar to flashing a vehicle's caution lights) when the following vehicle brakes to maintain the predetermined distance. As another example, the system may control the brake lights of the following vehicle to emit a specific color. In one approach, the system anticipates upcoming braking events of the lead vehicle (e.g., using global positioning system (GPS) data, recognizing upcoming stop signs/red lights, etc.). Responsive to a predicted event, the system activates the brake lights of the following vehicle in coordination with the activation of the brake lights of the lead vehicle. As yet another example, the following vehicle's left and right brake lights may be asynchronously activated to indicate how the following vehicle is braking. Further, the system may include activating a third brake light installed on the following vehicle to communicate to other road users that the following vehicle is connected to the lead vehicle while braking.

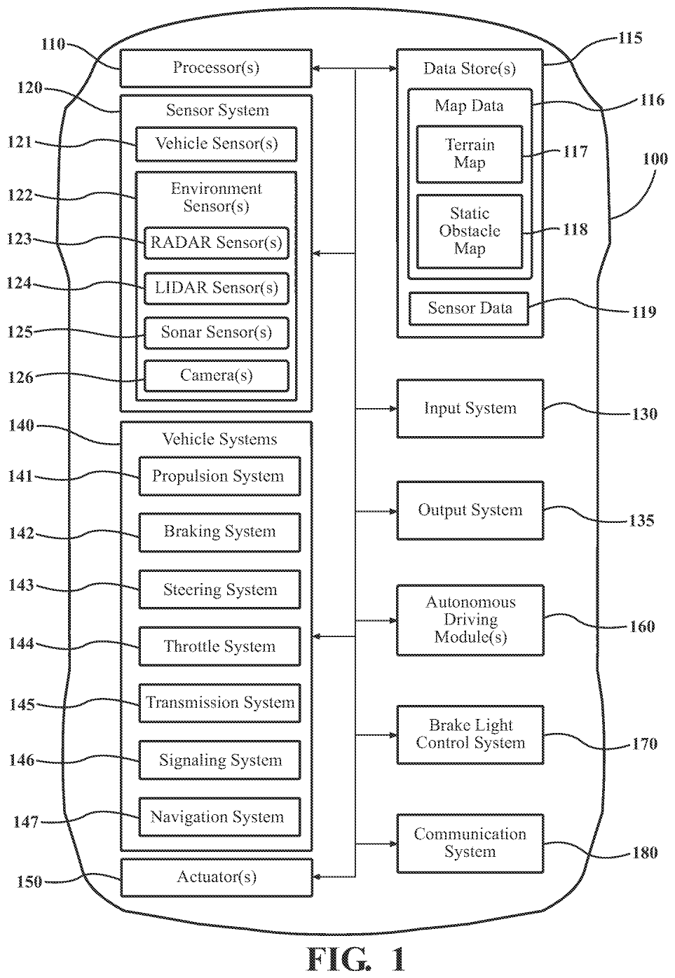

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, the vehicle 100 may be any robotic device or form of motorized transport that, for example, includes sensors to perceive aspects of the surrounding environment, and thus benefits from the functionality discussed herein associated with controlling brake lights of a following vehicle based on information obtained during a virtual connection mode. As a further note, this disclosure generally discusses the vehicle 100 as traveling on a roadway with surrounding vehicles, which are intended to be construed in a similar manner as the vehicle 100 itself. That is, the surrounding vehicles can include any vehicle that may be encountered on a roadway by the vehicle 100.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

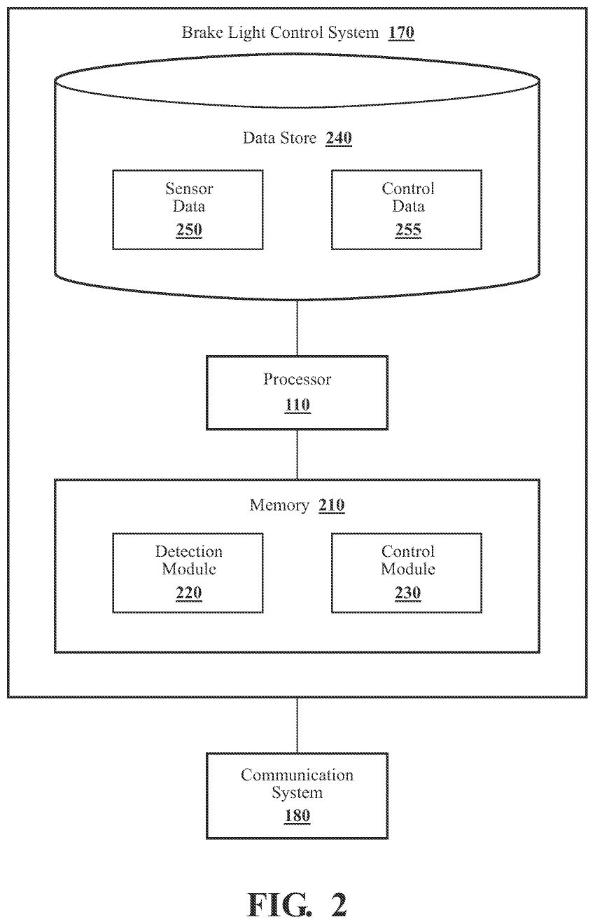

Some of the possible elements of the vehicle 100 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes a brake light control system 170 that is implemented to perform methods and other functions as disclosed herein relating to improving awareness and understanding of virtually-connected vehicles. As will be discussed in greater detail subsequently, the brake light control system 170, in various embodiments, is implemented partially within the vehicle 100, and as a cloud-based service. For example, in one approach, functionality associated with at least one module of the brake light control system 170 is implemented within the vehicle 100 while further functionality is implemented within a cloud-based computing system.

With reference to FIG. 2, one embodiment of the brake light control system 170 of FIG. 1 is further illustrated. The brake light control system 170 is shown as including a processor 110 from the vehicle 100 of FIG. 1. Accordingly, the processor 110 may be a part of the brake light control system 170, the brake light control system 170 may include a separate processor from the processor 110 of the vehicle 100, or the brake light control system 170 may access the processor 110 through a data bus or another communication path. In one embodiment, the brake light control system 170 includes a memory 210 that stores a detection module 220 and a control module 230. The memory 210 is a random-access memory (RAM), read-only memory (ROM), a hard-disk drive, a flash memory, or other suitable memory for storing the modules 220 and 230. The modules 220 and 230 are, for example, computer-readable instructions that when executed by the processor 110 cause the processor 110 to perform the various functions disclosed herein.

With reference to FIG. 2, the detection module 220 generally includes instructions that function to control the processor 110 to receive data inputs from one or more sensors of the vehicle 100. The inputs are, in one embodiment, observations of one or more objects in an environment proximate to the vehicle 100 and/or other aspects about the surroundings. As provided for herein, the detection module 220, in one embodiment, acquires sensor data 250 that includes at least camera images. In further arrangements, the detection module 220 acquires the sensor data 250 from further sensors such as a radar 123, a LiDAR 124, and other sensors as may be suitable for identifying vehicles and locations of the vehicles.

Accordingly, the detection module 220, in one embodiment, controls the respective sensors to provide the data inputs in the form of the sensor data 250. Additionally, while the detection module 220 is discussed as controlling the various sensors to provide the sensor data 250, in one or more embodiments, the detection module 220 can employ other techniques to acquire the sensor data 250 that are either active or passive. For example, the detection module 220 may passively sniff the sensor data 250 from a stream of electronic information provided by the various sensors to further components within the vehicle 100. Moreover, the detection module 220 can undertake various approaches to fuse data from multiple sensors when providing the sensor data 250 and/or from sensor data acquired over a wireless communication link (e.g., v2v) from one or more of the surrounding vehicles. Thus, the sensor data 250, in one embodiment, represents a combination of perceptions acquired from multiple sensors.

In addition to locations of surrounding vehicles, the sensor data 250 may also include, for example, information about lane markings, and so on. Moreover, the detection module 220, in one embodiment, controls the sensors to acquire the sensor data 250 about an area that encompasses 360 degrees about the vehicle 100 in order to provide a comprehensive assessment of the surrounding environment. Of course, in alternative embodiments, the detection module 220 may acquire the sensor data about a forward direction alone when, for example, the vehicle 100 is not equipped with further sensors to include additional regions about the vehicle and/or the additional regions are not scanned due to other reasons (e.g., unnecessary due to known current conditions).

Moreover, in one embodiment, the brake light control system 170 includes the data store 240. The data store 240 is, in one embodiment, an electronic data structure stored in the memory 210 or another data store and that is configured with routines that can be executed by the processor 110 for analyzing stored data, providing stored data, organizing stored data, and so on. Thus, in one embodiment, the data store 240 stores data used by the modules 220 and 230 in executing various functions. In one embodiment, the data store 240 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on.

In one embodiment, the data store 240 further includes control data 255. As described above, the present brake light control system 170 prevents a brake light of the following vehicle in a virtual connection from illuminating based on a default brake light signal and instead illuminates the brake light of the following vehicle based on information collected during, and associated with, the virtual connection mode. As such, the control data 255 refers to the data which governs brake light activation while in the virtual connection mode. As one particular example and as will be explained below, a default brake signal is prevented from illuminating the brake lights of the following vehicle when the duration of the brake light activation is less than a threshold period of time. In this case, the control data 255 includes the threshold against which the brake light activation is compared. In another example, the default brake signal is interrupted if there are more than a threshold number of signals passed in a predetermined window of time. The control data 255 in this example includes the threshold number and predetermined window of time such that the brake light control system 170 may evaluate whether these criteria are met.

The control data 255 also includes the lighting parameters for the virtual connection mode-based illumination. As will be described below, the brake lights of the following vehicle may be activated to emanate light of a particular color, frequency, sequence, and/or pattern that are uniquely associated with the virtual connection. In this example, the control data 255 identifies for the control module 230 how the brake lights should be activated once it is determined that the following vehicle is in a virtual connection mode.

As another example, virtual connection brake light activation may be based on a predicted braking event of the lead vehicle. As described above, the sensor data 250 includes information collected by the system of sensors on a vehicle, such as the lead vehicle. This sensor data 250 is used by a lead vehicle to anticipate, or recommend, a braking event for the lead vehicle. In this example, the sensor data 250 from the lead vehicle, or the predicted braking event identified based on the sensor data 250, is passed to the brake light control system 170 of the following vehicle. The control data 255 of the following vehicle may include instructions regarding the processing, analysis, and operations to be executed based on received sensor data 250 from the lead vehicle. While particular reference is made to particular types of control data 255, in general, any number of inputs may be received at the brake light control system 170 as a trigger to alter the operation of the following vehicle brake lights. The control data 255 provides instructions regarding how to mask, filter, replace, or otherwise manipulate the default brake light signal based on received data.

The detection module 220, in one embodiment, is further configured to perform additional tasks beyond controlling the respective sensors to acquire and provide the sensor data 250. For example, the detection module 220 includes instructions that cause the processor 110 to detect that a first vehicle and a second vehicle are in a virtual connection mode. That is, to effectuate the virtual connection between the first vehicle and the second vehicle, a communication path is set up between the two such that one vehicle, i.e., the lead vehicle, can provide driving and other commands to the second vehicle in the virtual connection. The detection module 220 detects that the first vehicle and a second vehicle are in a virtual connection mode in any number of ways. For example, the detection module 220 may identify the existence of the communication path between the first vehicle and the second vehicle. In another example, vehicles in the virtual connection mode may be set to certain operational states. In this example, the detection module 220 identifies the operational state of the vehicle 100 as indicia of the vehicle 100 being in the virtual connection mode. The virtual connection mode differs from a non-virtual connection mode in that while in a non-virtual connection mode, the vehicle 100 does not command another vehicle, nor is it commanded by another vehicle.

In one embodiment, the control module 230 generally includes instructions that function to control the processor 110 or collection of processors in the cloud-computing environment to control the operation of a vehicle brake light based on information while the vehicle is in the virtual connection mode. Such control is based on the first and second vehicles being in the virtual connection modes. That is, the control module 230 relies on an output from the detection module 220 that indicates the presence of the virtual connection to control the brake light activation.

Specifically, the control module 230 includes instructions to prevent a brake light of the following vehicle from illuminating based on a default brake light signal. That is, as described above, a following vehicle may repeatedly activate the brakes of the following vehicle to maintain a predetermined distance between the following vehicle and the lead vehicle. Default brake light signals activate the brake lights for each activation. Frequent and short adjustments to the exact position of the following vehicle may be needed to ensure precise compliance with the predetermined distance. The brake light illumination associated with these frequent and short adjustments leads to a flickering of the following vehicle brake lights, which may be an uncommon operation of brake lights that leads to user confusion when perceived. As such, the control module 230 prevents brake light flickering by preventing brake light illumination based on the default brake light signal.

Instead, the control module 230 illuminates the brake light of the following vehicle based on different information, specifically information obtained while the vehicle 100 is in the virtual connection mode. That is, when the vehicle 100 is in a non-virtual connection mode, the brake lights of the following vehicle are illuminated based on the default brake light signal, e.g., based on user brake input or a brake command originating from the following vehicle. By comparison, when in the virtual connection mode, the brake light activation is based on other information received while in the virtual connection mode. As one example, the control module 230 illuminates the brake light of the following vehicle based on a command to maintain the following vehicle a predetermined distance behind the lead vehicle. The form of illumination and the control data 255 associated with such may take a variety of forms.

In an example, the control module 230 prevents the brake light of the following vehicle from illuminating responsive to the default brake light signal indicating less than a threshold duration of brake light illumination. For example, the default brake light signal may apply brake pressure, activating an associated brake light, for less than 100 milliseconds (ms) in one instance. In this example, the control module 230 prevents the brake light illumination based on this 100 ms default brake light signal and may instead illuminate the brake light of the following vehicle for a duration of time that is greater than the threshold duration of brake light illumination. While particular mention is made of a specific threshold, the threshold against which brake light illumination is compared may be any value, including a value established by a user or an administrator of the virtual connection.

In an example, the control module 230 prevents the brake light of the following vehicle from illuminating responsive to greater than a threshold number of default brake light signals being received in a threshold period of time. As an example, to maintain a precise distance between the following vehicle and the lead vehicle, the default brake light signal may apply brake pressure in multiple times in a short window of time (e.g., ten times in two seconds). As such, the brake light flickers (e.g., ten times in two seconds), which may be confusing to a user such as a pedestrian or other motorist. In this example, the control module 230 prevents the brake light illumination based on these default brake light signals and may instead illuminate the brake light of the following vehicle for a duration of time that is greater than the threshold period of time. As such, rather than the brake light flickering ten times in two seconds, the brake light of the following vehicle may be continuously active for the entire two seconds. While particular mention is made of a specific flicker rate and threshold, the threshold against which brake light illumination is compared may be any value, including a value established by a user or an administrator of the virtual connection.

In an example, the control module 230 illuminates the brake light of the following vehicle based on information collected from the lead vehicle. In one specific example, a driver of the lead vehicle may apply brake pressure to slow down the lead vehicle. In this example, a signal generated responsive to the brake pressure application is transmitted to the brake light control system 170 of the following vehicle via the communication system 180. As such, the following vehicle may similarly apply brake pressure to decelerate the following vehicle in synchronization with the lead vehicle. The brake light control system 170 of the following vehicle may illuminate the brake lights of the following vehicle based on the brake pressure signal from the lead vehicle.

In an example, the brake light control system 170 receives, through the communication system 180, a predicted braking event of the lead vehicle. The predicted braking event may be identified based on information collected from the system of sensors on the lead vehicle. As a specific example, the sensors of the lead vehicle may identify a pedestrian crossing the street in front of the lead vehicle. Responsive to this data, the lead vehicle may predict or recommend that the lead vehicle decelerates by applying brake pressure. In this example, this sensor data may be passed to the following vehicle, either after the application of lead vehicle brake pressure or before the application of lead vehicle brake pressure. As such, the control module 230 may illuminate the brake light of the following vehicle based on the predicted braking event of the lead vehicle.

The brake lights of the following vehicle may be activated based on any number of illumination parameters. For example, the brake lights may be activated to emanate the same color as when in a non-virtual connection mode, albeit modified as described above (e.g., extending the length of the brake light activation). In one example, the control module 230 applies different illumination characteristics to the brake lights based on information obtained during the virtual connection mode. For example, the control module 230 may illuminate a left brake light and a right brake light asynchronously responsive to a brake command from the lead vehicle. By comparison, in a non-virtual connection mode, the left and right brake light may be illuminated simultaneously. The asynchronous and distinct activation pattern may be uniquely used for virtual connection identification, thus communicating to a nearby user of the virtual connection.

In an example, the control module 230 illuminates the brake light of the following vehicle in a particular pattern at a particular frequency that is uniquely associated with the virtual connection mode. For example, the illumination of the brake lights, based on either a command from a lead vehicle or based on the alteration of a default brake light signal to be longer than a threshold period of time as described above, may be at a particular frequency and/or pattern different from any used while in a non-virtual connection mode such that nearby users are notified that the vehicles are traveling in a coordinated fashion.

In an example, the control module 230 illuminates the brake light of the following vehicle in a particular color uniquely associated with the virtual connection. That is, a brake light may include different colored lighting elements, such as a red color element to illuminate the brake lights based on a default brake light signal when the vehicle 100 is in a non-virtual connection mode. The brake light system may include a lighting element of a different color to illuminate based on information obtained during the virtual connection mode. This differently colored lighting element may be continuously activated or activated based on a braking activation signal, such as a brake activation command from a lead vehicle or based on a default brake signal as adjusted by control data 255 when in the virtual connection mode.

In an example, the control module 230 provides a light command signal for additional brake light elements found on the vehicle 100. For example, the vehicle 100 may include additional lighting elements, in addition to a right brake light and a left brake light, that illuminates responsive to a default brake light signal. In this example, the control module 230 alters this additional lighting element similar to those methods described above.

Note that while particular reference is made to particular illumination parameters, the control module 230 may alter other illumination parameters of the brake lights to avoid flickering of the brake lights, other user confusion, and to otherwise notify the other users of the virtual connection. As described, information relating to the illumination parameters of the brake lights is stored as control data 255 in the data store 240.

In an example, the brake light of the following vehicle is illuminated in a manner and fashion that is distinct from the brake light illumination of the lead vehicle. While it may be that the following vehicle brake light activation mirrors that of the lead vehicle, illuminating the following vehicle brake lights and the lead vehicle brake lights may provide knowledge regarding the virtual connection. For example, the asynchronous activation of the lead vehicle braking lights and the following vehicle braking lights may indicate that the following vehicle autonomous control systems are having difficulty maintaining the predetermined distance between itself and the lead vehicle.

As such, the brake light control system 170 detects when the following vehicle is in a virtual connection mode, that is when the following vehicle is virtually connected to a lead vehicle. When the following vehicle is in a virtual connection mode, the brake light control system 170 filters, masks, adjusts, replaces, or otherwise manipulates the brake light control signal to prevent light flickering and/or indicate the virtual connection between the two vehicles. Doing so reduces confusion surrounding the virtual connection and reduces the probability of unsafe or undesirable characteristics of the virtual connection configuration.

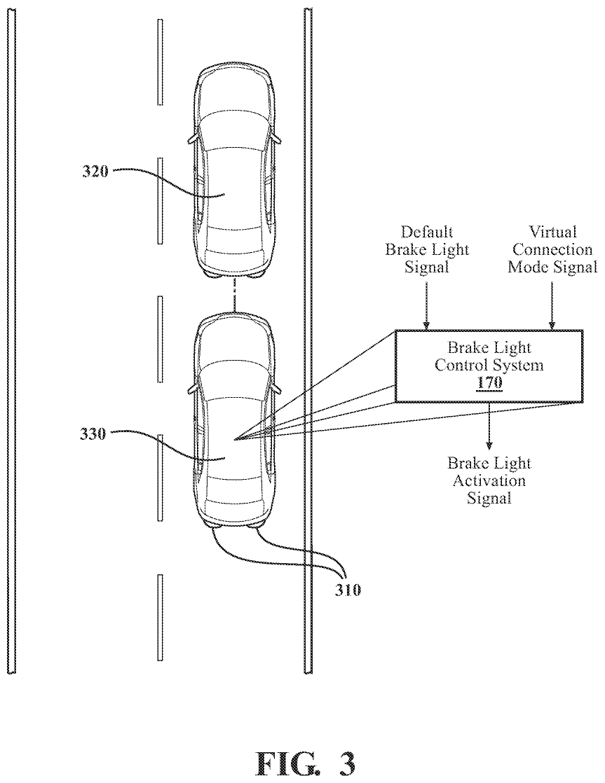

FIG. 3 illustrates one example of controlling the brake lights 310 of a following vehicle 330 based on information obtained during the virtual connection mode. As described above, a virtual connection exists when a lead vehicle 320 at least partially controls the movement of a following vehicle 330. The lead vehicle 320 and the following vehicle 330 are examples of the vehicle 100 described in connection with FIG. 1. In this example, the second vehicle 330 will follow the trajectory of the first vehicle 320 based on control signals received at the second vehicle 330 from the first vehicle 320. In FIG. 3, the virtual connection is indicated as a dashed line between the first vehicle 320 and the second vehicle 330.

As the virtually-connected vehicles travel along a particular roadway, they will encounter various other road users, such as pedestrians and other vehicles. While other road users are familiar with vehicles traveling on roadways, such road users may be confused with hitchless towing, platooning or other forms of virtual connection configurations. Unfamiliar operations of either vehicle exacerbate this confusion. One example of an unfamiliar operation is when the brake lights 310 of the following vehicle 330 flicker responsive to incremental use of the brakes of the following vehicle 330 to maintain the following vehicle 330 a predetermined distance away from the lead vehicle 320. These fine tune adjustments result in a flickering of the brake lights 310 of the following vehicle 330 may confuse users in the vicinity of the vehicles and/or a dangerous situation for road users, the virtually-connected vehicles, and other bystanders.

As such, the following vehicle 330, which is an example of the vehicle 100 depicted in FIG. 1, includes a brake light control system 170 to illuminate the brake lights 310 based on information collected while the following vehicle 330 is in a virtual connection mode with the lead vehicle 320. Specifically, the brake light control system 170 receives the default brake light signal of the following vehicle 330 and prevents brake light activation based on the default brake light signal. Instead, the brake light control system 170 activates the brake lights based on a virtual connection mode signal. That is, as described above, the control module 230 of the brake light control system 170 receives an output indicating that the following vehicle 330 is in a virtual connection mode with the lead vehicle 320. Responsive to this indication, the brake light control system 170 generates a brake light activation signal that is based on 1) the signal indicating the following vehicle is in a virtual connection mode and 2) control data 255 indicating how the brake lights should be activated while in the virtual connection mode. The brake light control system 170 may illuminate the brake lights 310 of the following vehicle 330 as described above in a manner to reduce user confusion that may result when brake lights flicker as the following vehicle 330 adjusts operation to maintain a predetermined distance between the following vehicle 330 and the lead vehicle 320.

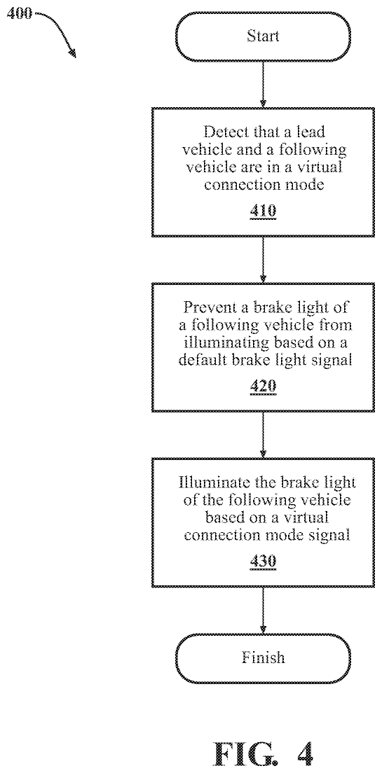

Additional aspects of brake light control will be discussed in relation to FIG. 4. FIG. 4 illustrates a flowchart of a method 400 that is associated with controlling brake lights 310 of a following vehicle 330 based on information obtained when the following vehicle 330 is in a virtual connection mode. Method 400 will be discussed from the perspective of the brake light control system 170 of FIGS. 1, and 2. While method 400 is discussed in combination with the brake light control system 170, it should be appreciated that the method 400 is not limited to being implemented within the brake light control system 170 but is instead one example of a system that may implement the method 400.

At step 410, the detection module 220 detects that a first vehicle 320 and a second vehicle 330 are in a virtual connection mode. As described above, a virtual connection mode of a vehicle 100 refers to when the vehicle 100 is either 1) a lead vehicle providing control functions to other vehicles in a hitchless towing, virtual towing, or platooning configuration or 2) a following vehicle that is receiving control commands from a lead vehicle. This may be detected in any number of ways, for example, by identifying the state of the vehicle 100 based on information stored in memory or by detecting a virtual connection communication path between the vehicle 100 and another vehicle.

At step 420, the control module 230 prevents a brake light 310 of the following vehicle 330 from illuminating based on a default brake light signal. That is, a default brake light signal may activate a brake light 310 each time a brake actuator of the following vehicle 330 is activated. This may result in the flickering of the brake light 310 as fine-tune adjustments are made by the brake actuator of the following vehicle 330. Preventing brake light activation by the default brake light signal may include interrupting a signal directed towards the brake light 310 from the brake actuator or a native brake actuator controller.

At step 430, the control module 230 illuminates the brake light 310 of the following vehicle 330 based on a virtual connection mode signal or other information obtained during the virtual connection mode. Such illumination may include altering the default brake light signal by, for example, extending a duration of the brake light activation when the default brake light signal triggers 1) brake light activation for a sub-threshold duration of time or 2) multiple brake light activations in a threshold period of time. In an example, the illumination based on the virtual connection mode signal is based on information received from the lead vehicle 320, such as an actual braking event at the lead vehicle or a predicted braking event at the lead vehicle. In an example, the illumination is a virtual connection-specific illumination pattern, frequency, and/or color. That is, in addition to reducing the flickering of the brake lights 310, the brake light control system 170 may also distinguish virtual connection use of the vehicle compared to non-virtual connection use of the vehicle via illumination using different, virtual connection-specific lighting parameters.

As such, the present brake light control system 170 reduces user confusion by masking, filtering, or replacing brake light activation via a default brake light signal with a brake light activation signal based on information obtained during the virtual connection mode. Such a system reduces the likelihood of a dangerous situation arising from adjacent users being confused by, unfamiliar with, or unaware of virtually-connected vehicles in their immediate vicinity.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system or a geolocation system.

The processor(s) 110, the brake light control system 170, and/or the automated driving module(s) 160 can be operatively connected to communicate with the various vehicle systems 140 and/or individual components thereof. For example, returning to FIG. 1, the processor(s) 110 and/or the automated driving module(s) 160 can be in communication to send and/or receive information from the various vehicle systems 140 to control the movement, speed, maneuvering, heading, direction, etc. of the vehicle 100. The processor(s) 110, the brake light control system 170, and/or the automated driving module(s) 160 may control some or all of these vehicle systems 140 and, thus, may be partially or fully autonomous.

The processor(s) 110, the brake light control system 170, and/or the automated driving module(s) 160 can be operatively connected to communicate with the various vehicle systems 140 and/or individual components thereof. For example, returning to FIG. 1, the processor(s) 110, the brake light control system 170, and/or the automated driving module(s) 160 can be in communication to send and/or receive information from the various vehicle systems 140 to control the movement, speed, maneuvering, heading, direction, etc. of the vehicle 100. The processor(s) 110, the brake light control system 170, and/or the automated driving module(s) 160 may control some or all of these vehicle systems 140.

The processor(s) 110, the brake light control system 170, and/or the automated driving module(s) 160 may be operable to control the navigation and/or maneuvering of the vehicle 100 by controlling one or more of the vehicle systems 140 and/or components thereof. For instance, when operating in an autonomous mode, the processor(s) 110, the brake light control system 170, and/or the automated driving module(s) 160 can control the direction and/or speed of the vehicle 100. The processor(s) 110, the brake light control system 170, and/or the automated driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the automated driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the brake light control system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. In general, the automated driving module(s) 160 may function to implement different levels of automation, including advanced driving assistance (ADAS) functions, semi-autonomous functions, and fully autonomous functions. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to, when a lead vehicle and a following vehicle are in a virtual connection mode:
prevent a brake light of the following vehicle from illuminating based on a default brake light signal; and
illuminate the brake light of the following vehicle based on information obtained during the virtual connection mode.

2. The system of claim 1, wherein the machine-readable instructions comprise instructions that, when executed by the processor, cause the processor to, when the lead vehicle and the following vehicle are in a non-virtual connection mode, illuminate the brake light of the following vehicle based on the default brake light signal.

3. The system of claim 1, wherein the machine-readable instruction to illuminate the brake light of the following vehicle comprises an instruction that, when executed by the processor, causes the processor to illuminate the brake light based on a command to maintain the following vehicle a predetermined distance behind the lead vehicle.

4. The system of claim 1, wherein the machine-readable instruction to prevent the brake light of the following vehicle from illuminating comprises an instruction that, when executed by the processor, causes the processor to prevent the brake light of the following vehicle from illuminating responsive to the default brake light signal indicating less than a threshold duration of brake light illumination.

5. The system of claim 4, wherein the machine-readable instruction to illuminate the brake light of the following vehicle comprises an instruction that, when executed by the processor, causes the processor to illuminate the brake light of the following vehicle for a duration of time that is greater than the threshold duration of brake light illumination.

6. The system of claim 1, wherein the machine-readable instruction to prevent the brake light of the following vehicle from illuminating comprises an instruction that, when executed by the processor, causes the processor to prevent the brake light of the following vehicle from illuminating responsive to greater than a threshold number of default brake light signals being received in a threshold period of time.

7. The system of claim 6, wherein the machine-readable instruction to illuminate the brake light of the following vehicle comprises an instruction that, when executed by the processor, causes the processor to illuminate the brake light of the following vehicle for a duration of time that is greater than the threshold period of time.

8. The system of claim 1, wherein the machine-readable instruction to illuminate the brake light of the following vehicle comprises instructions that, when executed by the processor, cause the processor to:
receive a signal indicating a predicted braking event of the lead vehicle; and
illuminate the brake light of the following vehicle based on the predicted braking event of the lead vehicle.

9. The system of claim 1, wherein the machine-readable instruction to illuminate the brake light of the following vehicle comprises at least one of:
an instruction that, when executed by the processor, causes the processor to illuminate a left brake light and a right brake light asynchronously responsive to a brake command from the lead vehicle;
an instruction that, when executed by the processor, causes the processor to illuminate the brake light of the following vehicle in a particular pattern at a particular frequency uniquely associated with the virtual connection mode; and
an instruction that, when executed by the processor, causes the processor to illuminate the brake light of the following vehicle in a particular color uniquely associated with the virtual connection mode.

10. The system of claim 1, wherein the machine-readable instruction to illuminate the brake light of the following vehicle comprises an instruction that, when executed by the processor, causes the processor to illuminate the brake light of the following vehicle in a pattern that is distinct from a brake light illumination of the lead vehicle.
